(19) United States
(12) Patent Application Publication
(10) Pub. No.: US 2008/0313263 A1
(43) Pub. Date: Dec. 18, 2008

(54) Method of Employing a Computer Network to Regulate Contact Between Economic Development Officials and Site Selectors

(76) Inventor: Donald Holbrook, Lake Havasu City, AZ (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 12/170,111

(22) Filed: Jul. 9, 2008

Related U.S. Application Data
(63) Continuation of application No. 10/137,198, filed on May 2, 2002, now abandoned.

(51) Int. Cl. G06F 15/16

(52) U.S. Cl. 709/201

(57) ABSTRACT

Disclosed is a computerized network, such as the world wide web, wherein a method of facilitating contact between economic development officials and site selectors is employed. The method enables site selectors to access a community profile database to find community information for potential development sites. Economic development officials are notified when their information s accessed. The system also enables site selectors to generate automated RFPs.

### RELATED APPLICATION DATA

This application is a continuation of co-pending application Ser. No. 10/137,198, the contents of which are incorporated herein.

This application claims priority from provisional application Ser. No. 60/288,945 filed on May 4, 2001 entitled Site Selection RFP/Lead Generation System, the contents of which are incorporated herein by reference. This application also claims priority from provisional application Ser. No. 60/288,679 filed on May 4, 2001 entitled Economicdeveloper.com, the contents of which are incorporated herein by reference.

### BACKGROUND OF THE INVENTION

1. Field of the Invention

This invention relates to a means for facilitating the interaction of economic development officials and site selectors. More particularly, the present invention relates to facilitating such interaction over a computer network, such as the world wide web.

2. Description of the Background Art

Presently it is known to employ to the Internet to offer business leads or generate requests for proposals (RFPs) on line. For example, www.globalbizdir.com and www.localbusiness.com function as virtual marketplaces for economic development activities. Likewise U.S. Pat. No. 6,112,188 to Hartnett discloses a computerized method for developing and implementing economic policies. The method includes the step of preparing a privatization business plan, reviewing a privatization plan by a privatization board, executing the plan, restructuring the enterprise in accordance to the plan and submitting an application for certification of demonopolization to a privatization board. These steps are carried out by way of a computer system.

Furthermore it is also known to employ the Internet for more general economic activity. For instance, U.S. Pat. No. 6,247,130 to Fritsch discloses a system and method for permitting the purchase of audio music files over the Internet. Likewise U.S. Pat. No. 6,078,866 discloses an Internet site searching and listing service based upon monetary rankings of site listings.

Although each of the above referenced inventions achieves its individual objective, they all suffer from common problems. Specifically, none of the background art discloses the use of a computer network to facilitate the interaction between an economic development official and a site selector. Moreover none of the background art discloses utilizing a computer network for the purposes of updating a database containing information regarding specific communities and development sites.

### SUMMARY OF THE INVENTION

The method of the present invention is ideally carried out in a Web-based application designed to facilitate economic development (ED) site selection processes in a business to business (B2B) environment. To carry out these processes, professional economic development officials (EDOs) representing public sector interests collect, manage, and disseminate community information in order to attract new business to their communities; and business enterprises considering relocation retain the services of site selection consultants or real estate professionals (site selectors) to search for and solicit proposals from prospective relocation sites.

Rapid exchange of accurate information is key to achieving both public and private sector site selection objectives. Both groups want clear, easy-to-compare, up-to-date information (preferably standardized data) to support accurate comparisons. On the other hand, EDOs and site selectors have conflicting preferences for how site selection data and processes are managed.

EDOs must be able to rapidly assemble and disseminate current information about their communities to prospective site selectors, and they want data systems that are easy to manage and maintain. EDOs prefer to have personal communication with identified prospects, they'd like to know what regions they're competing against, and they want to provide as much information about their communities as possible.

In contrast, site selectors prefer to remain anonymous, and they often maintain anonymity until the final stages of selection. They like to receive only the most relevant information about sites they've selected for consideration, and they want current and accurate data in a form suitable for easy comparison since they are evaluating a number of competing sites.

The method of the present invention is designed to satisfy these competing objectives. In brief, the present Web-based application gives EDOs and site selectors customized extranet-type access to a request for proposal (RFP) project management tool that integrates up-datable sets of industry standard data. The system facilitates information exchange, enhances accountability, and supports best RFP management practices for EDOs and site selectors. The elements of the application are described in detail in the Detailed Description of the preferred embodiment.

It is therefore one of the objectives of this invention to provide a method wherein EDOs and site selectors can exchange updated community and site data in an efficient and expedient manner.

It is also an object of this invention to keep EDOs notified regarding interest in their community by site selectors.

Still another object of this invention is to enable site selectors to generate RFPs on an automated basis.

These and other objectives are accomplished by providing a method for regulating the contact between EDOs and site selectors. The method involves gathering relevant community and site information from EDOs and storing this information in a database. Thereafter, site selectors are permitted to search the database on the basis of their predetermined solution criteria.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is an overview of the method of the present invention.

FIG. 2 is a flowchart demonstrating the new user interview process.

FIG. 3 is a flowchart depicting the login process employed in the system of the present invention.

FIG. 4 is a listing of the various types of users of the method of the present invention.

FIG. 5 is a flowchart of the lead generation system of the present invention.

FIG. 6 is a flowchart demonstrating the site agent feature of the present invention.

FIG. 7 is a flowchart depicting the business assistance detective aspect of the present invention.

FIG. 8 is a flowchart depicting the cost benefit analysis agent of the present invention.

FIG. 9 is a flowchart demonstrating the community profiler agent aspect of the present invention.

FIG. 10 is a flowchart depicting the project tracker aspect of the present invention.

FIG. 11 is a flowchart depicting the information agent aspect of the present invention.

FIG. 12 is a flowchart depicting the shopkeeper agent aspect of the present invention.

Similar reference characters refer to similar parts throughout the several views of the drawings.

### DETAILED DESCRIPTION OF THE PREFERRED EMBODIMENT

The present invention relates to a method of utilizing a computer network, such as the world wide web, to regulate and facilitate contact between economic development officials (EDOs) and site selectors. EDOs are professionals, typically in the public sector, with economic development training and expertise who carryout economic development activities on behalf of community or municipal entities. Site selectors are consultants and/or real estate professionals who search for and solicit proposals from prospective sites on behalf of businesses seeking to locate or relocate their enterprises.

In accordance with the present invention, site selectors employ the computer network to access a database containing the community and site information of various EDOs. Furthermore EDOs are notified whenever their community and site information has been accessed by a site selector. Such interchange of information satisfies the competing objectives of the EDOs and site selectors. That is, site selectors are given access to updated relevant community information and EDOs are given leads regarding potential economic development contacts. The various aspects of the method of the present invention are elaborated upon more fully hereinafter.

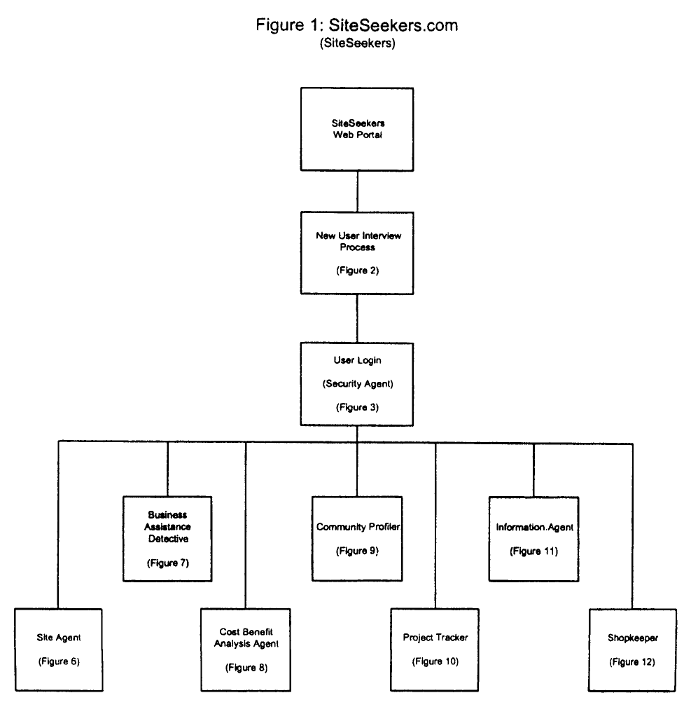

FIG. 1 is a schematic overview of the method of the present invention with individual boxes disclosing various steps in the method. Certain boxes contain references to additional figures wherein additional details are provided. As discussed, the method of the present invention is ideally carried out by way of a computer network. A suitable computer network would have one or more servers interconnected to various personal computers via a telephone line, or cable modem, icon line or the like. One preferred computer network is the world wide web. Thus in the preferred embodiment the blocks of FIG. 1 each represent one or more web pages written in hypertext markup language (HTML). The HTML code would be resident upon a server accessible by one or more computers over the computer network.

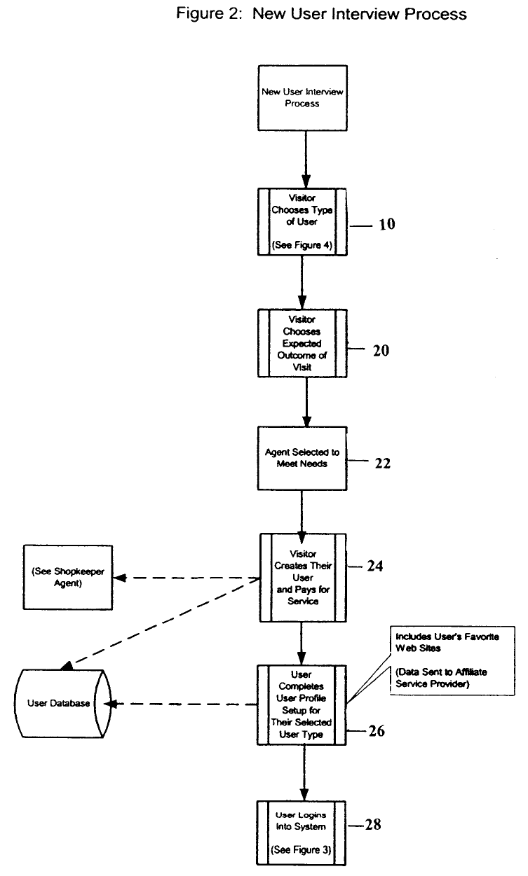

FIG. 1 illustrates the web portal for the website of the present invention. FIG. 1 also discloses the new user interview process and the user login features of the method. After the new user interview process is conducted and a user is logged in they are directed to one or more “agents”. These agents are one or more subpages within the site which are specific needs of the user. These needs are ascertained during the interview process (FIG. 2) when the system gathers information regarding the type of user logging on to the system.

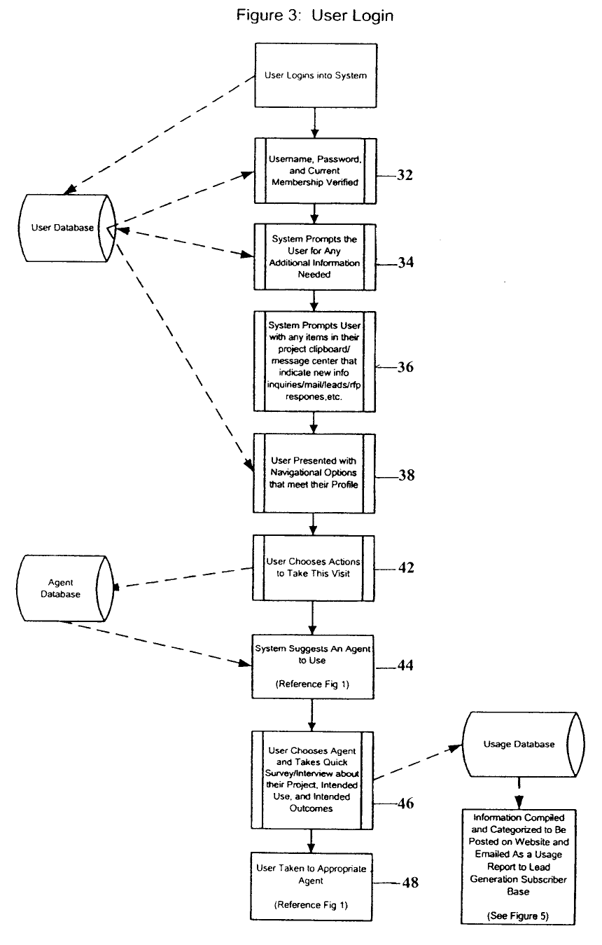

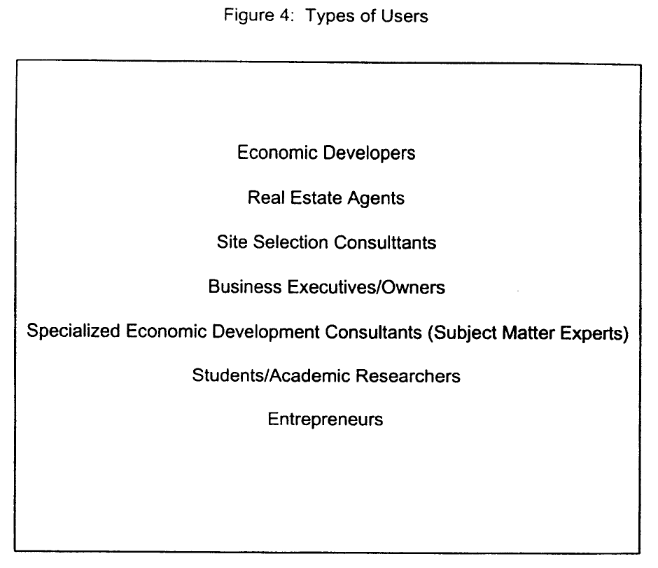

It is envisioned that a variety of different types of users may employ the system of the present invention. For example, as illustrated in FIG. 4, the user may be an economic developer; a real estate agent; a site selection consultant; a business executive owner; a specialized economic development consultant; a student academic researcher; or an entrepreneur. During the initial new user interview the specific type of user is determined and the users needs are determined accordingly. Although various types of users are designated in FIG. 4 they can all be generally classified into two groups: EDOs and site selectors. During the interview process, further information is gathered regarding the type of objectives the user wishes to achieve by way of the method. Thereafter the user tenders payment for use of the site and is then assigned a password and ID. Although payment can be tendered, it is within the scope of the present invention to provide access to the site for free. Alternatively, the user may pay for only those portions that they use or they may access the site on a subscription basis. These features of the present invention are elaborated upon more fully hereinafter in conjunction with FIGS. 2 through 3.

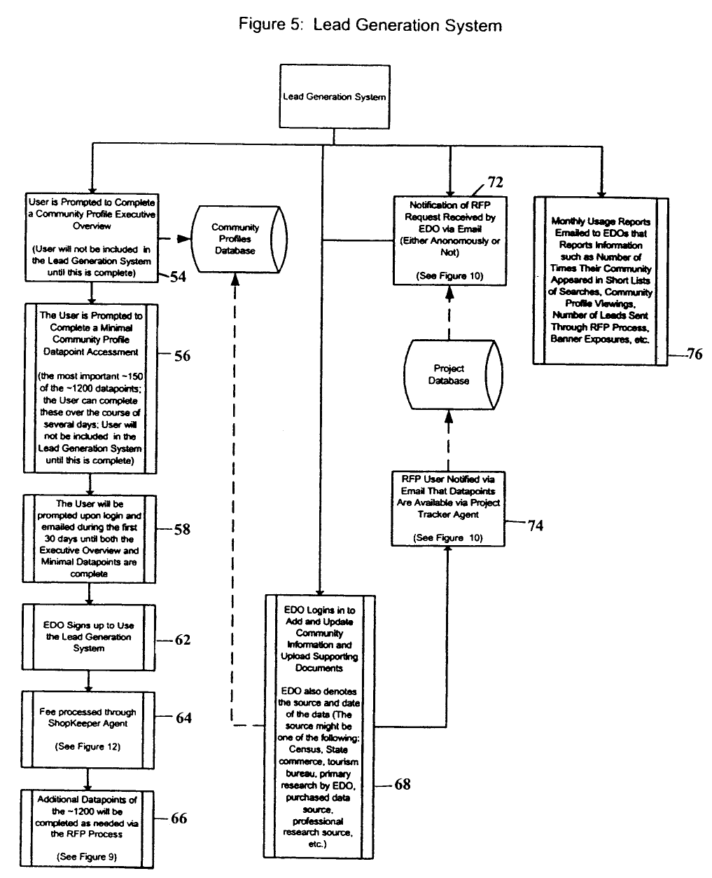

When the individual logging in is an EDO, the system will gather relevant community and site information that the EDO is willing to share. This information is a compilation of data concerning the individual community being marketed by the EDO and ideally takes the form of community profile datapoints and community profile executive overviews. The community profile data points are industry standard data established by a joint task force sponsored by the American Economic Development Counsel (AEDC), the Council for Urban Economic Development (CUED), and the Economic Developers Association of Canada. The AEDC and CUED have merged and are now know as the International Economic Development Council (IEDC). The executive overviews are narrative descriptions detailing relevant community information. Once this information is gathered it is stored on the computer network in a community profile database. This database can be occasionally accessed and updated by EDOs as needed, or in response to RFPs, to ensure that their community and site information is as up to date and comprehensive as possible. This aspect of the method is elaborated upon more fully hereinafter in conjunction with FIG. 5.

Once the community profile database is established it can be accessed and searched by site selectors who desire information regarding specific communities searches by site selectors would be based upon their predefined selection criteria. For example, site electors may be interested in only those communities with certain scores on select datapoints, or they may be interested in communities with certained qualities discussed in executive overviews. In this regard before searching the database site selectors can assign weighted or increased, values to the community profile data points with the weighted values representing the desired community qualities they are seeking. The results of the search are then displayed for subsequent review by the site selectors on an individual search by a site selector may uncover a number of different community profiles representing the submissions of numerous EDOs.

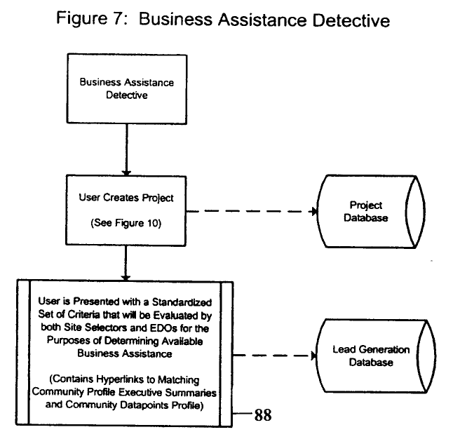

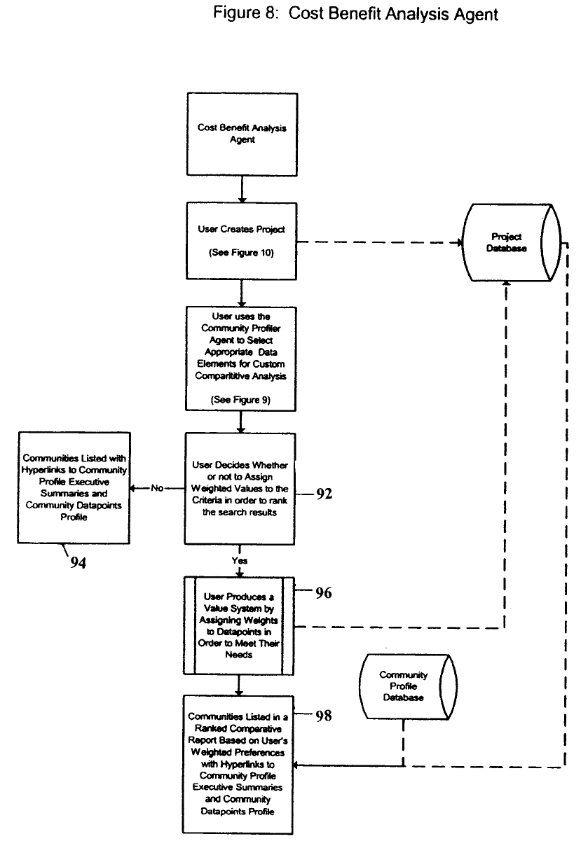

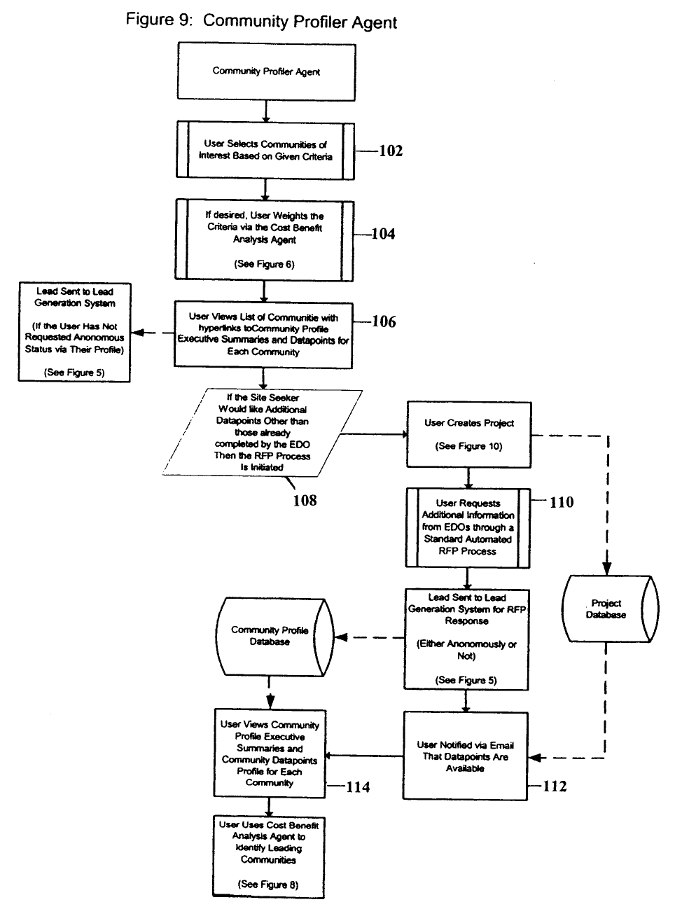

In a further aspect of the method, those EDOs whose community information has been accessed or displayed are notified of such by way of the computer network. In the preferred embodiment the notification is carried out by email. The notification permits EDOs to be aware of interest by a site selector and further allows the EDOs to keep track of the number and frequency of such contacts. Moreover the system allows site selectors to request additional community and site information from specific EDOs. For example, a search by a site selector may uncover a particular community of interest. However, the relevant EDO may not have completed or provided all the community profile data points that the site selector is interested in. Consequently in accordance with the present invention the site selector can request additional community and site information from a particular EDO. This request comes in the form of a Request for Proposal (RFP). As noted in FIG. 9, the RFP is automatically generated by way of the community profile and project databases. These databases compile the additional information needed by the site selector and forward the compiled information to the appropriate EDO. Thereafter the EDO can update their particular database to include the requested information. This can include providing relevant supporting documentation for the requested data. The requested information then becomes part of the particular EDOs database for future reference. This aspect of the present invention is described more fully hereinafter in conjunction with FIGS. 8 through 9. After the EDO has updated their database, the requesting site selector is notified of such via the network. Now that the method has been described generally, the specific subpages constituting the site of the present invention will be described in greater detail with reference to FIGS. 2-12.

### Input of Information

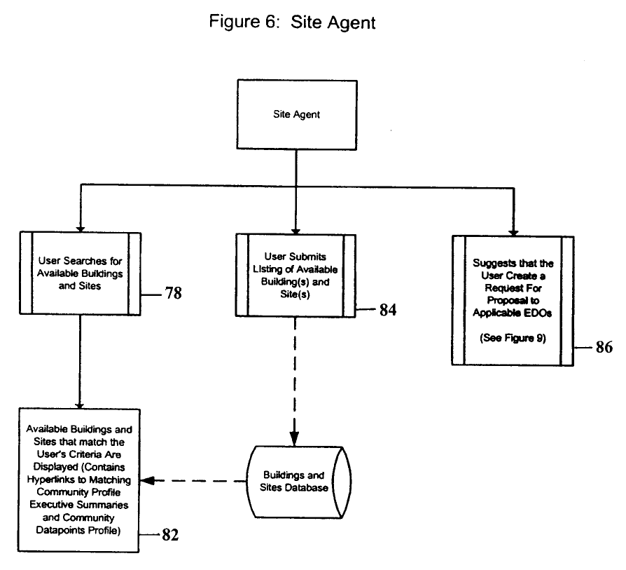

With reference now to FIGS. 2, 3 and 5 the logon and data input aspects of the method will be described. FIGS. 2 and 3 illustrate the initial steps of the present invention. As with FIG. 1, FIGS. 2 and 3 are flowcharts with each block depicting one or more web pages in HTML code that can be accessed by a user. In the new user interview process depicted in FIG. 2 at location 10 an individual first decides which type of user they are. The most typical user types are listed in FIG. 4. However, most all users to the site will be classified either as economic developers or site selectors. Next at location 20 the visitor chooses the expected outcome of their visit. Namely the user specifies that information which they are seeking or those objectives they which to achieve by employing the site. On the basis of this input a particular “agent” is selected. That is that area of the web site (as noted in FIG. 1 and in more detail in FIGS. 6 through 12) which is most capable of assisting the user is selected. Thereafter the user creates a user profile and, if the service permits, tenders payment for use of the website (location 24). Thereafter additional user profile information can be requested at location 26 and thereafter the user can logon to the system (location 28).

The user logon is depicted in the flowchart of FIG. 3. Logging on is achieved by a user providing the user name password and current membership information as illustrated at location 32. All this information is checked relative to a user database. As is typical in such situations, the system can prompt the user for any additional login information that is needed (note location 34). After logging in, the system prompts the user with any new information regarding their user account or their particular economic development activity that has transpired since their last visit to the site. Likewise the site may prompt a user of contact from another user of the site. These prompts are carried out at location 36. The user database is then again accessed to present the user with navigational options (location 38) that are specific to their user profile. Thereafter the user decides what actions they will take during their visit to the website (location 42). The desired action is then compared to an agent database and the system suggests a particular agent to use Location 44). Again the agent is an indication of which portion of the website is most like to achieve the objectives of the user. The various agents contained within the site are depicted in the lower half of FIG. 1. Thereafter the user either chooses the suggested agent (location 46) or is taken to an appropriate agent (Location 48).

Whenever a new EDO enters the system they will be prompted for relevant information regarding their community. The information is stored in the community profile database. This aspect of the method is depicted in FIG. 5. This lead generation system enables EDOs to store any data they wish to have accessed by site selectors in the hopes of generating leads for economic development purposes. As indicated in FIG. 5, under the lead generation system a user is prompted to complete a community profile executive overview (location 54). This overview will contain a narrative description of particular community that the EDO is marketing. The EDO will be further prompted for at least a minimal community profile datapoint assessment (location 56). There are roughly 1,200 industry standard datapoints relevant to community profiles. However, the present system permits users to insert a far fewer number of datapoints. Nonetheless, the minimum number of datapoints is not inserted the EDO will be prompted upon subsequent logons to provide additional datapoints (location 56). Additionally, the EDO will be emailed during the first 30 days after the initial login until the minimum datapoints are complete (location 58). After these datapoints are received, the EDO can sign up to use the site (location 62) for a fee (location 64). By using the system, the EDO is notified when their particular community and site information is accessed by a site selector (location 76). This notification can take the form of monthly usage reports emailed to EDOs, such reports indicating the frequency with which the EDOs community data was accessed.

Additionally, by signing up to use the site EDOs are notified when a site selector submits a RFP (location 72). As a result of the RFP, the EDO will be permitted to update their community and site information (location 68). Site selectors submitting RFPs are then notified of the update information (location 74). If desired, the RFP process can be carried out anonymously. All of the community and site information of a particular EDO is stored in a community profile database. The community and site information can include documentation such as census information, state commerce information, tourism convention information and/or local community or other primary research.

### Searching by Site Selectors

Next, searching of the site by site selectors is described.

FIG. 6 is a flowchart demonstrating a simplistic search that can be performed by a site selector employing the method of the present invention. Specifically, a site selector can login to the website and search for available buildings and sites (location 78). Likewise EDOs can login to the website and list available buildings and sites (location 84). This information is more specific than the broader community information stored in the community profile database. The building and sites listed by the EDOs, or other real estate professionals, are stored in a buildings and sites database. As such, a search by a site selector will list those buildings and sites that match the users criteria (location 82). To facilitate searching by site selectors the building and site data is indexed by specified criteria. The displayed building and site information can contain hyperlinks to relevant information and can further contain the community profile executive summaries and community datapoints, as desired. Moreover, as discussed previously, the particular site selector can generate a RFP to a particular EDO (location 86).

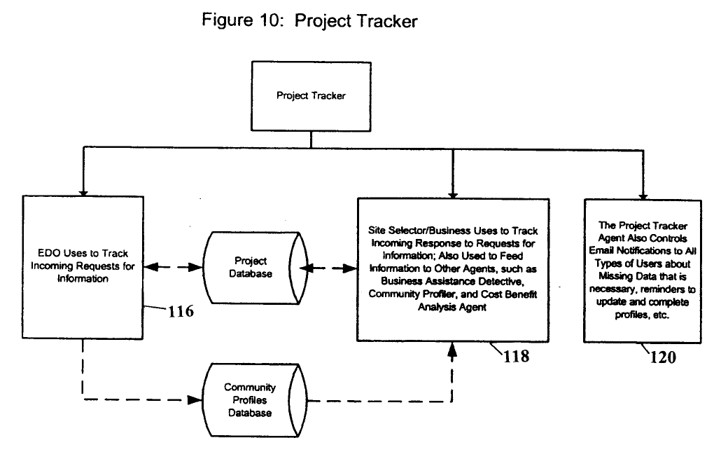

Likewise a site selector can employ the website of the present invention to conduct a cost benefit analysis (note FIG. 8). Specifically the site selector first creates a particular project (FIG. 10) which stores information concerning a particular search, as will be described in fuller detail hereinafter. Next, the site selector selects the appropriate datapoints for custom comparative analysis, as detailed. As mentioned previously the site selector can decide whether or not to weight certain datapoints more heavily than other datapoints depending upon their predefined selection criteria (location 92). If not weighting is necessary, a listing is generated as a result of the non-weighted data (location 94). Otherwise, weighted values are assigned (location 96) and a display of communities is generated based upon weighted preferences (location 98).

As further illustrated in FIG. 9, in addition to searching the community profile database the site selector can initiate an RFP process (location 108). Specifically, once the site selector initiates the RFP process a particular project is defined (note FIG. 10) such that the site selector can request additional information from an EDO through a standard automated RFP process (location 110). Once the RFP process is initiated the lead generation system generates a lead to be sent to the EDO (note FIG. 5), assuming that the RFP is not anonymously initiated by the site selector. As noted and explained in FIG. 5 once the EDO is notified of the RFP process, they will update the community profile database accordingly with the desired additional information. Once the database is updated the site selector is notified via email that the datapoints are available (location 112). Thereafter the site selector can view the community profile executive summaries and the datapoints for each relevant community (location 114). Once a specific list of communities is generated a cost benefit analysis can be conducted (note FIG. 8) to further define the selections.

The flowchart of FIG. 10 illustrates the project tracking feature of the present invention. Specifically an EDO can employ a project database to keep track of the incoming requests for information (location 116). That is each individual request for information would be assigned a particular project number and that project number would be stored within the project database. Likewise the site selector can use the same project database to track incoming responses to their various requests for information (location 118). The project tracker also controls all email notifications to all users for example notifications regarding missing datapoints and/or reminders to update and complete profiles etc. (location 120)

### Ancillary Features

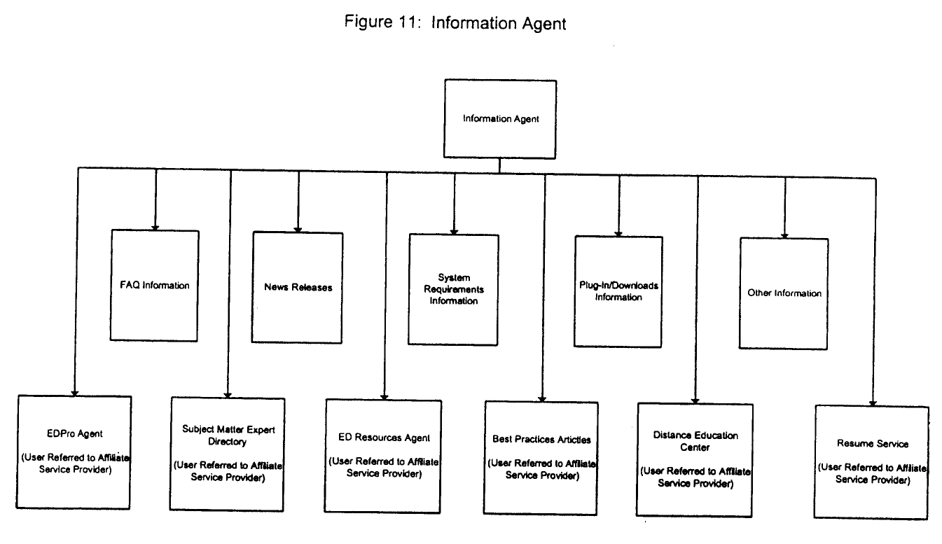

The method of the present invention would also employ ancillary features to provide additional desired functionality. For example the site would include an information agent as noted in FIG. 11. The information agent would include various information and/or links which would be required to fully utilize the site or which would be of particular relevance to the economic development community. For example the information the agent may have a page of frequently asked questions, news releases concerning economic development, system requirements for utilizing the website, plug-ins or downloads to take advantage of the functionality of the site and other information as needed. Likewise the information agent may have a subject matter directory or resources for general economic development concerns, best practice articles and a resume service as needed. A distance education center and an ed pro agent can also be included.

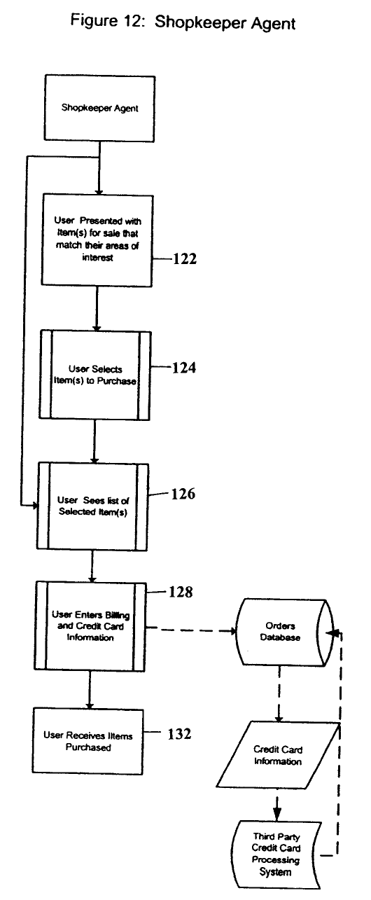

An additional ancillary feature would be a shopkeeper agent as noted in FIG. 12. The shopkeeper agent would present the user with various items for sale based upon the areas of interest of the user (location 122). These areas of interest would be determined on the basis of information provided to the system during the new user interview process. Their items would be displayed to the user (location 126). By way of the shopkeeper agent the user can select items to purchase (location 124) and can employ billing or credit card information to buy the items (location 128).

Yet another ancillary service would be a business assistants detective. This feature of the method would present users (both EDOs and site selectors) with a standardized set of criteria that would be a evaluated for the purposes of determining available business assistance. Such business assistance would come in the form of tax breaks, community grants or other such benefits of interest to potential site selectors or EDOs.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method of employing a computer network to regulate contact between a plurality of economic development officials (EDOs) and a plurality of site selectors whereby site selectors are permitted to access the community and site information of EDOs and wherein EDOs are notified when their community and site information has been accessed, the method comprising the following steps:
gathering information regarding the EDOs and site selectors employing the computer networks;
assigning passwords to individual EDOs and individual site selectors;
gathering a plurality of community and site information from various EDOs, the plurality of community and site information including community profile data points and community profile executive overviews;
receiving updates over the computer network from EDOs, whereby the updates update the EDOs' respective community and site information;
storing the plurality of community and site information on the computer network in a community profile database;
assigning weighted values to community profile data points based upon site selectors' selection criteria;
accessing and searching of the community profile database by site selectors, wherein communities and sites meeting the selection criteria of site selectors can be selected and displayed and wherein the weighted community profile data points are taken into account; and
notifying via the computer network those EDOs whose community and site information has been displayed by a site selector.

2. A method of regulating contact between economic development officials (EDOS) and site selectors comprising the following steps:
gathering a plurality of community and site information from various EDOs, the plurality of community and site information including community profile datapoints and community profile executive overviews;
storing the plurality of community and site information on a computer network in a community profile database;
accessing and searching of the community profile database by site selectors, wherein communities and sites meeting the selection criteria of site selectors can be selected and displayed.

3. The method of claim 2 further comprising the step of gathering information regarding the EDOs and site selectors and assigning passwords to individual EDOs and site selectors.

4. The method as described in claim 2 further comprising the step of assigning weighted values to the community profile datapoints based upon site selectors' selection criteria.

5. The method as described in claim 2 wherein those EDOs whose community and site information has been displayed by a site selector are notified.

6. The method as described in claim 5 wherein the EDOs are notified via electronic mail.

7. The method as described in claim 2 further comprising the steps of: requesting additional community and site information from EDOs whereby the site selectors request additional community and site information; and updating the community profile database whereby the EDOs update the community profile database.

8. The method as described in claim 2 wherein the method of regulating contact is carried out over a computer network.

9. The method as described in claim 2 wherein the community profile datapoints are the industry standard datapoints as defined by the International Economic Development Council.
